(19) United States
(12) Patent Application Publication
(10) Pub. No.: US 2010/0293198 A1
(43) Pub. Date: Nov. 18, 2010

(54) MOBILE PHOTO SHARING

(76) Inventors: Joseph L. Marinucci, Moultonborough, NH (US); Luis A. Ruelas, JR., Blauvelt, NY (US); Matthew Goodman, Cortlandt Manor, NY (US)

Correspondence Address: FRASER CLEMENS MARTIN & MILLER LLC, 28366 KENSINGTON LANE, PERRYSBURG, OH, 43551, US

(21) Appl. No.: 12/778,792

(22) Filed: May 12, 2010

Related U.S. Application Data
(60) Provisional application No. 61/177,364, filed on May 12, 2009.

(51) Int. Cl. G06F 17/30; G06F 15/16; H04W 4/12

(52) U.S. Cl. 707/784; 707/805; 709/204; 455/466; 707/802; 707/E17.044

(57) ABSTRACT

A photo sharing system includes a database including a user account, a mobile device for sending and receiving a digital image, wherein the digital image has a source identification associated with the user account, and a management server for receiving the digital image, analyzing the source identification associated with the digital image, and automatically storing the digital image on the database in response to the analysis of the source identification.

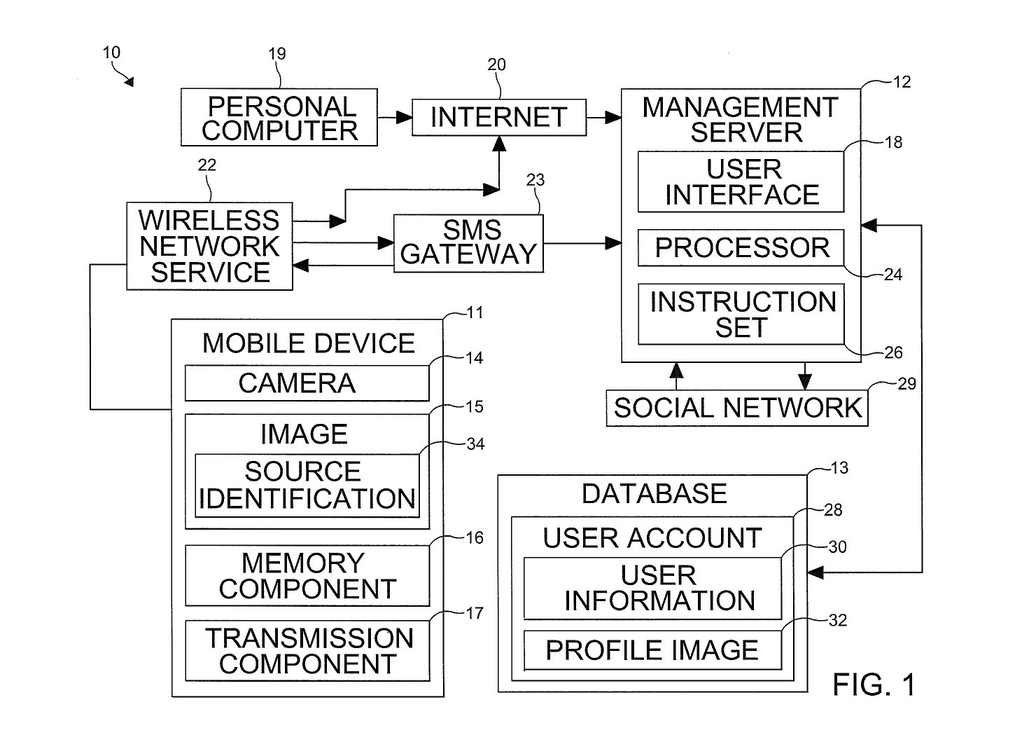

### CROSS-REFERENCE TO RELATED APPLICATIONS

The present application claims priority to U.S. Provisional Application Ser. No. 61/177,364 filed May 12, 2009, hereby incorporated herein by reference in its entirety.

### FIELD OF THE INVENTION

The invention generally relates to social networking. More particularly, the invention is directed to a photo sharing system and method for sharing digital photographs.

### BACKGROUND OF THE INVENTION

As technology advances, electronic devices continue to become smaller and include more features. Currently, electronic devices such as cell phones and personal digital assistants (PDAs), for example, often include phone, email, and media capturing/playing capabilities. Typically, digital cameras that are integrated into the electronic devices produce photos having a photo quality that is sufficiently high to allow the electronic device to be used as a primary camera.

One drawback with camera-integrated electronic devices is the relative complexity in sharing stored photos between multiple devices. For example, some electronic devices are connected to a printer to create hard-copy prints and then the user manually inserts the images into a photo album. Users often find this process somewhat complicated and restrictive because standard printers can only print images in limited sizes and require particular types of paper. Even after the photo album has been assembled, the printed images are not easily shared with many people.

The best approaches to photo-sharing take advantage of the Internet. One such approach is for users to store the digital images on a PC and then send the images to others using email.

It would be desirable to develop a photo sharing system and method for sharing digital photographs, wherein the photo sharing system and method provide a social network for multiple users to conveniently send and receive digital photographs between a plurality of mobile electronic devices.

### SUMMARY OF THE INVENTION

Concordant and consistent with the present invention, a photo sharing system and method for sharing digital photographs, wherein the photo sharing system and method provide a social network for multiple users to conveniently send and receive digital photographs between a plurality of mobile electronic devices, has surprisingly been discovered.

In one embodiment, a photo sharing system comprising: a database including a user account; a mobile device for sending and receiving a digital image, wherein the digital image has a source identification associated with the user account; and a management server for receiving the digital image, analyzing the source identification associated with the digital image, and automatically storing the digital image on the database in response to the analysis of the source identification.

In another embodiment, a photo sharing system comprising: a database including a plurality of pre-registered user accounts; a mobile device including a digital camera for capturing a digital image and a transmission component for sending and receiving the digital image, wherein the digital image has a source identification associated with at least one of the user accounts; a management server for receiving the digital image, analyzing the source identification to determine the at least one of the user accounts associated with the digital image, and storing the digital image on the database in response to the analysis of the source identification; and a user interface for accessing at least one of the database and the management server to manage the user account.

The invention also provides methods for sharing digital photographs.

One method comprises the steps of: establishing a user account including a pre-defined social network having a plurality of pre-defined members, wherein the user account is stored on a database; capturing a digital image with a mobile device; transmitting the digital image to a management server, the captured digital image including a source identification associated with the user account, wherein the management server analyzes the source identification to determine the associated user account; transmitting the digital image to the user account associated therewith; and automatically transmitting the digital image to the members of the social network.

### BRIEF DESCRIPTION OF THE DRAWINGS

The above, as well as other advantages of the present invention, will become readily apparent to those skilled in the art from the following detailed description of the preferred embodiment when considered in the light of the accompanying drawing which is a schematic diagram of the photo sharing system according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Referring to the drawing, there is illustrated a photo sharing system 10 according to an embodiment of the present invention. As shown, the photo sharing system 10 includes a mobile device 11 in communication with a management server 12 and a database 13. It is understood that any number of mobile devices, servers, and databases may be included.

The mobile device 11 is typically a personal electronic device such as a cellular phone, a smart phone, and a personal digital assistant (PDA), for example. The mobile device 11 includes a camera 14 for capturing a digital image 15. However, other means for capturing an image may be used such as linking the mobile device 11 to a digital camera, for example. In certain embodiments, the mobile device 11 further includes a memory component 16 for storing captured digital images and a transmission component 17 for sending and receiving digital images. As a non-limiting example, the transmission component 17 is capable of transmitting and receiving data (e.g. images) via at least one of an electronic mail service, a SMTP (Simple Mail Transport Protocol), a SMS (Short messaging Service), and a MMS (Multimedia Messaging Service). However, it is understood that other protocols and data transfer services can be used.

The management server 12 is typically an SQL (Structured Query Language) server. However, other languages and servers may be used. In certain embodiments, the management server 12 includes a user interface 18 for allowing a user to access at least one of the management server 12 and the database 13. As a non-limiting example, the user interface 18 is a web application including various interactive web pages such as a login page, a registration page, an administrative page, and a profile page, for example.

The management server 12 is adapted to intercommunicate with an electronic device such as the mobile device 11 and a personal computer (PC) 19, send and receive digital images therebetween, and manage the transmission, storage, and printing of the received digital images. As a non-limiting example, the management server 12 communicates with the electronic devices through at least one of an intranet, the Internet 20, and a wireless network service 22. However, other means for communication may be used. As a further non-limiting example, an SMS gateway 23 is in data communication with the mobile device 11 and the management server 12 to facilitate a data communication therebetween.

In certain embodiments, the management server 12 includes a processor 24 adapted to control the functions of the management server 12 based upon an instruction set 26. Specifically, the instruction set 26, which may be embodied within any computer readable medium, includes processor executable instructions for configuring the processor 24 to perform a variety of tasks. As a non-limiting example, the instruction set 26 may be computer coded instructions for a web application. As a further non-limiting example, the instruction set 26 may be stored in the database 13.

The database 13 is an SQL database in communication with the management server 12. However, other languages may be used for server-database compatibility. In certain embodiments the database 13 is adapted to store data and information related to a plurality of registered user accounts 28. For example, the database 13 may include a “My Mobile Pictures” folder for storing digital photographs received by a particular user and further transmitting a notification to a pre-defined groups of recipients (e.g. a social network 29), the notification indicating that new digital photographs have been stored in the associated “My Mobile Pictures” folder. It is understood that other information may be stored on the database 13 such as contact information for social networking and photo sharing.

In certain embodiments, each of the user accounts 28 includes a user information 30 associated with a particular user to identify the particular user such as a username, a password, a cell phone number, and an e-mail address, for example. It is understood that any identification and communication information can be associated with any of the user accounts 28.

In certain embodiments, a profile image 32 is associated with at least one of the registered user accounts 28, wherein the profile image 32 is viewable by other users and members through the user interface 18. As a non-limiting example, each user may upload a personalized image to be used as the profile image 32. As a further example, the profile image 32 can be custom character (referred to as PhotoMe's) designed in classic cartoon fonts. As such, the profile image 32 provides a reduced profile while providing a viewable icon to all other users and registered members.

In use, the user accesses the management server 12 through the user interface 18 (e.g. web application). Specifically, the user may create one of the registered user accounts 28 by providing the user information 30. Furthermore, a profile image 32 may be associated with the registered user account 28, wherein the profile image 32 is viewable by other users and members through the user interface 18.

Once the user has established one of the registered user accounts 28, the user captures the digital image 15 using the mobile device 11. The captured image 15 (i.e. digital photograph) is transmitted to the management server 12 via at least one of email, SMTP (Simple Mail Transport Protocol), SMS (Short messaging Service), and MMS (Multimedia Messaging Service). It is understood that transmission and communication may be determined by the technology available on a particular mobile device. However, any means of transmitting a digital photograph may be used. The digital image 15 is transmitted with a source identification 34 associated with the means used to transmit the digital image 15. As a non-limiting example, the source identification 34 can be a phone number associated with the mobile device 11 used to transmit the digital image 15. As a further non-limiting example, the source identification 34 can be an electronic mail address of the user transmitting the digital image 15. It is understood that any personal or communication information can be used to “tag” the digital image 15 with the source identification 34. It is further understood that the source identification 34 can be similar to at least a portion of the user information 30 associated with at least one of the user accounts 28.

The digital image 15 is received by the management server 12 and the processor 24 analyzes the received data to detect the source identification 34 (e.g. a cellular phone number, an e-mail address, and the like). Once the source identification 34 for the particular digital image 15 is determined, the management server 12 uses an SQL query to match the source identification 34 to an associated one of the registered user accounts 28 on the database 13. In certain embodiments, an analysis of the source identification 34 of the digital image 15 includes comparing the source identification 34 to the user information 30 of various user accounts 28 to determine whether the source identification 34 matches the user information 30 of any of the user accounts 28. Once a match is detected, the management server 12 stores the digital image 15 to the associated (i.e. matched) one of the registered user accounts 28. As a non-limiting example, the user is sent a confirmation message from the management server 12 indicating that the digital image 15 has been received and successfully uploaded to the associated registered user account 28 on the database 13.

The system 10 also provides sharing capabilities to users to allow sending and receiving of any date (e.g. the digital image(s) 15) stored on the database 13 to any electronic device. Specifically, the user may access the management server 12 through the user interface 18 to define the social network 29 associated with the registered user account 28. As a non-limiting example, the user may provide any number of cell phone numbers and e-mail addresses to be associated with the respective registered user account 28. As such, the management server 12 may be programmed to automatically transmit particular date (e.g. the digital image(s) 15) to the members of the social network 29 defined by the user. As a further example, the user may define a particular permission level associated with each member of the social network 29, wherein the permission level defines a member's access and control over the user's stored data (e.g. digital image(s) 15).

The photo sharing system and method provides a means to conveniently and easily share and print digital photographs captured by the mobile device 11. No special downloads or middleware is necessary. Furthermore, the digital image 15 captured by a user and sent to the associated registered user account 28 is viewable to the entire social network 29 defined by the user. Users may send and receive between a plurality of the mobile devices 11 as easily as they can capture the digital image 15.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A photo sharing system comprising:
a database including a user account;
a mobile device for sending and receiving a digital image, wherein the digital image has a source identification associated with the user account; and
a management server for receiving the digital image, analyzing the source identification associated with the digital image, and automatically storing the digital image on the database in response to the analysis of the source identification.

2. The photo sharing system according to claim 1, wherein the mobile device includes a camera for capturing the digital image.

3. The photo sharing system according to claim 1, wherein the mobile device includes a memory component for storing the digital image.

4. The photo sharing system according to claim 1, wherein the mobile device includes a transmission component capable of transmitting the digital image via at least one of an electronic mail, a Simple Mail Transport Protocol, a Short Messaging Service, and a Multi-media Messaging Service.

5. The photo sharing system according to claim 1, wherein the user account of the database includes a user information associated with a particular user to identify the particular user.

6. The photo sharing system according to claim 1, wherein the user account of the database includes a pre-defined social network associated with the user account.

7. The photo sharing system according to claim 6, wherein a member of the social network has selective access to the user account.

8. The photo sharing system according to claim 6, wherein a member of the social network has selective access to the digital image stored on the database.

9. A photo sharing system comprising:
a database including a plurality of pre-registered user accounts;
a mobile device including a digital camera for capturing a digital image and a transmission component for sending and receiving the digital image, wherein the digital image has a source identification associated with at least one of the user accounts;
a management server for receiving the digital image, analyzing the source identification to determine the at least one of the user accounts associated with the digital image, and storing the digital image on the database in response to the analysis of the source identification; and
a user interface for accessing at least one of the database and the management server to manage the user account.

10. The photo sharing system according to claim 9, wherein the transmission component is capable of transmitting the digital image via at least one of an electronic mail, a Simple Mail Transport Protocol, a Short Messaging Service, and a Multi-media Messaging Service.

11. The photo sharing system according to claim 9, wherein the user account of the database includes a user information associated with a particular user to identify the particular user.

12. The photo sharing system according to claim 9, wherein the user account of the database includes a pre-defined social network associated with the user account.

13. The photo sharing system according to claim 12, wherein a member of the social network has selective access to the digital image stored on the database.

14. The photo sharing system according to claim 9, wherein the user interface is a web application.

15. A method for sharing digital photographs, the method comprising the steps of:
establishing a user account including a pre-defined social network having a plurality of pre-defined members, wherein the user account is stored on a database;
capturing a digital image with a mobile device;
transmitting the digital image to a management server, the digital image including a source identification associated with the user account, wherein the management server analyzes the source identification to determine the associated user account;
transmitting the digital image to the user account associated therewith; and
automatically transmitting the digital image to the members of the social network.

16. The method according to claim 15, wherein the digital image is transmitted to the management server via at least one of an electronic mail, a Simple Mail Transport Protocol, a Short Messaging Service, and a Multi-media Messaging Service.

17. The method according to claim 15, wherein the user account includes a user information associated with a particular user to identify the particular user.

18. The method according to claim 17, wherein the analysis of the source identification of the digital image includes comparing the source identification to the user information to determine of the source identification matches the user information.

19. The method according to claim 17, wherein the members of the social network are defined by the user information.

20. The method according to claim 15, wherein the user account is established via a web application.
